(19) United States
(12) Patent Application Publication
(10) Pub. No.: US 2006/0163151 A1
(43) Pub. Date: Jul. 27, 2006

(54) Composition adsorbent and method for producing thereof, and water purification material and water purifier

(75) Inventors: Shuji Kawasaki, Okayama-ken (JP); Haruo Nakada, Tokyo-to (JP); Yasuhiro Tajima, Okayama-ken (JP); Hiroe Yoshinobu, Okayama-ken (JP); Erika Maeda, Osaka-ku (JP); Kiyoto Otsuka, Okayama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Chemical Co., Ltd., Okayama-ken (JP)

(21) Appl. No.: 10/532,499

(22) PCT Filed: Oct. 28, 2003
(86) PCT No.: PCT/JP03/13759

§ 371 Date: Sep. 6, 2005

(30) Foreign Application Priority Data
Oct. 29, 2002 (JP) 2002-314009

(51) Int. Cl. B01D 39/02

(52) U.S. Cl. 210/502.1; 210/504; 210/505; 210/506; 210/508; 210/263

(57) ABSTRACT

A composite adsorbent which comprises a composite powder composed of a particulate compound, a plastic powder adhered to the compound, and at least one adsorptive substance selected from powdery, particulate and fibrous substances; a composite material adsorbent which comprises a particulate compound and at least one adsorptive substance selected from powdery, particulate and fibrous substances, both of which have the plastic powder adhered thereto; methods for producing composite adsorbents; a water purification material comprising a composite adsorbent; and a water purifier comprising a composite material. The composite adsorbent exhibits a reduced resistance when a liquid passes through it, and is excellent in performance capabilities for the removal of free chlorine, THM, a heavy metal and the like. The composite adsorbent also provides water transmitted through it with satisfactory clarity, and is less prone to cause discrepancies in performance capabilities between respective purifiers.

### TECHNICAL FIELD

The present invention relates to a composite adsorbent and a method for production thereof, and a water purification material and a water purifier. More particularly, the present invention relates to a composite adsorbent from which a fine powder does not flow during use and a method for producing the composite adsorbent, and a water purification material and a water purifier. The present invention provides a composite adsorbent which comprises a composite powder (c) composed of a particulate compound (a) and a plastic powder (b) adhered to the compound and at least one adsorptive substance (d) selected from powdery, particulate and fibrous substances, and provides a composite adsorbent which comprises the particulate compound (a) and at least one adsorptive substance (d) selected from powdery, particulate and fibrous substances, both of which have the plastic powder (b) adhered thereto. If the composite adsorbents are used as water purification materials for a water purifier, these exhibit a reduced resistance when a liquid passes therethrough and are excellent in performance capabilities for the removal of free chlorine, THM, heavy metals and the like, so that these provide the water transmitted therethrough with satisfactory clarity. Therefore, the composite adsorbents are suitable for water purifiers.

### BACKGROUND ART

Activated carbon is excellent in adsorbability to adsorb various contaminants and has been conventionally used as an adsorbent material in various fields regardless of domestic or industrial purposes. In recent years, delicious water having neither a chlorine odor nor a musty odor has been demanded, and, so far, various types of water purifiers have been proposed in response to this demand. However, recently, safety and hygienic concerns have also increased with regard to water quality that has been affected by total trihalomethanes (hereinafter, abbreviated as “THM”), endocrine disrupters, heavy metals, etc., and it is insufficient to meet demand only with the activated carbon. Therefore, activated carbon is required to be used together with other adsorbent materials, such as inorganic compounds that have specific adsorbabilities.

Especially in the field of water clarification, the Environment Agency regards heavy metals, especially lead ions, as suspected substances that constitute endocrine disrupters. Accordingly, it is of urgent necessity to develop an effective water clarifying material, considering that the lead ion concentration contained in drinking water is to be restricted from 50 ppb or less, which is the current regulatory value, to 10 ppb or less in 2003.

As a water clarifying material excellent in capabilities to remove free chlorine, mustiness, THM, and heavy metals in drinking water, the present applicant has developed an activated-carbon structure formed with a mixture consisting of a fibrous activated carbon, titanium dioxide, silicon dioxide, and a binder, and has filed a patent application (Patent Document 1). The activated-carbon structure disclosed here is the one formed with a mixture consisting of a fibrous activated carbon, titanium dioxide, silicon dioxide, and a binder, and the structure obtained by subjecting a particulate article, which is chiefly composed of titanium dioxide and silicon dioxide, and a fibrous activated carbon to wet molding is highly effective in removing heavy metals, such as lead ions, contained in water.

[Patent Document 1] Japanese Published Unexamined Patent Application No. 2000-256999

The present applicant has additionally proposed an activated-carbon structure that is excellent in adsorptivity to adsorb heavy metals, that is capable of adsorbing and removing free chlorine and THM in a well-balanced manner, and that is low in resistance occurring when a liquid passes therethrough (Patent Document 2). The activated-carbon structure proposed here is the one that carries a fine particulate compound, which is chiefly composed of titanium dioxide and silicon dioxide, entangled in a fibrillated fiber on particulate activated carbon, and is excellent in removing heavy metals while having a reduced resistance of a liquid passed therethrough and maintaining the performance capabilities to remove free chlorine, THM, etc., in a well-balanced manner without impairing the performance capabilities inherent in activated carbon.

[Patent Document 2] International publication WO03/022425A1

However, when a water purifier is used independently, there are cases in which an extremely small quantity of turbid water occurs especially at the beginning of the passage of water therethrough. This phenomenon can be solved by using the water purifier in combination with other filtering means such as hollow fiber membranes. However, the truth is that nonturbid water is demanded even when the water purifier is used independently. Although turbidity occurs as a result of the flaking of a particulate compound and is harmless, clarity is an important factor especially when the water is used as drinking water.

Additionally, when a water purifier is filled with adsorbent materials, there are cases in which a classification occurs from a difference in fill-specific gravity between the adsorbent materials and in which discrepancies in adsorbability between respective purifiers are caused by the fact that the adsorbent materials provided to the purifiers differ in quantity between the purifiers. Especially when adsorbent materials having relatively large particle diameters are used, discrepancies in adsorbability between respective purifiers are liable to be prominently caused.

It is therefore an object of the present invention to provide a composite adsorbent that exhibits a reduced resistance when a liquid is passed therethrough, that is excellent in removing heavy metals while maintaining performance capabilities for the removal of free chlorine, THM, heavy metals, etc., in a well-balanced manner, that provides the water transmitted therethrough with highly satisfactory clarity without allowing a fine powder of a particulate compound to flow out when the water is passed therethrough, and that is less prone to cause discrepancies in performance capabilities between respective purifiers resulting from the occurrence of a classification, provide a method for producing the composite adsorbent, and provide a water purification material made of the composite adsorbent and a water purifier using the water purification material.

### DISCLOSURE OF INVENTION

To achieve the object, the present inventors have diligently made repeated examinations, and, as a result, have found that the object can be achieved by the following composite adsorbent, and have reached the present invention. That is, the object can be achieved by (1) a composite adsorbent that comprises a composite powder (c), which is composed of a particulate compound (a) and a plastic powder (b) adhered to the compound, and at least one adsorptive substance (d) selected from powdery, particulate and fibrous substances; (2) a composite adsorbent that comprises the particulate compound (a) and at least one adsorptive substance (d) selected from powdery, particulate and fibrous substances, both of which have the plastic powder (b) adhered thereto; a method for producing the composite adsorbent; a water purification material; and a water purifier. In other words, a first aspect of the present invention is a composite adsorbent that comprises a composite powder (c), which is composed of a particulate compound (a) and a plastic powder (b) adhered to the compound, and at least one adsorptive substance (d) selected from powdery, particulate and fibrous substances.

A second aspect of the present invention is a composite adsorbent that comprises the particulate compound (a) and at least one adsorptive substance (d) selected from powdery, particulate and fibrous substances, both of which have the plastic powder (b) adhered thereto.

A third aspect of the present invention is a composite powder (c) in which the plastic powder (b) is adhered to the particulate compound (a).

A fourth aspect of the present invention is a method for producing a composite adsorbent mixed with an adsorptive substance, the composite adsorbent being obtained such that a mixture obtained by mixing a plastic powder and a particulate compound together is heated beyond the melting point of the plastic powder, is then cooled, and is sieved.

A fifth aspect of the present invention is a method for producing a composite adsorbent obtained such that a mixture obtained by mixing a plastic powder, a particulate compound, and an adsorptive substance together is heated beyond the melting point of the plastic powder, is then cooled, and is sieved while being crushed.

A sixth aspect of the present invention is a water purification material made of the composite adsorbent mentioned above.

A seventh aspect of the present invention is a water purifier that uses the water purification material.

### BRIEF DESCRIPTION OF DRAWINGS

FIG. 1 is an electron microscope photograph (180 magnifications) of a composite powder obtained in Example 1;

FIG. 2 is an electron microscope photograph (650 magnifications) of the composite powder obtained in Example 1;

FIG. 3 is an electron microscope photograph (2,500 magnifications) of the composite powder obtained in Example 1;

FIG. 4 is a graph showing a relationship between lead removal efficiency (%) and the quantity (L) of passed water, which are measured while using a composite adsorbent as a water purification material, in Example 1 and Comparative Example 1;

FIG. 5 is an electron microscope photograph (60 magnifications) of a composite powder obtained in Example 11;

FIG. 6 is an electron microscope photograph (200 magnifications) of the composite powder obtained in Example 11; and

FIG. 7 is a graph showing a relationship between lead removal efficiency (%) and the quantity (L) of passed water, which are measured while using a composite adsorbent as a water purification material, in Example 11 and Comparative Example 3.

### BEST MODE FOR CARRYING OUT THE INVENTION

A composite adsorbent in the first aspect of the present invention is characterized by using a composite powder (c) in which a plastic powder (b) is adhered to a particulate compound (a). A water purifier that has a reduced resistance when a liquid passes therethrough, that can sufficiently exhibit the performance capabilities to remove free chlorine, THM, heavy metals, etc., and that is extremely excellent in permeability of permeated water can be provided by using the composite adsorbent composed of the composite powder and at least one adsorptive substance (d) selected from powdery, particulate and fibrous substances as a water purification material.

A composite adsorbent in the second aspect of the present invention comprises the particulate compound (a) and at least one adsorptive substance (d) selected from powdery, particulate and fibrous substances, both of which have the plastic powder (b) adhered thereto, whereby it is possible to provide a water purification material that is less prone to cause discrepancies in performance capabilities between respective purifiers resulting from the occurrence of a classification.

A compound having an ion exchanging function excellent in the adsorptivity of soluble heavy metals can be mentioned as a particulate compound preferably used for water clarification. Herein, the compound having an ion exchanging function is a compound that can emit ions into a salt aqueous solution by contact with the solution and take therein ions in the solution.

Aluminosilicate typified by zeolite, titanosilicate, titanium dioxide, silicon dioxide, hydroxyapatite, bone charcoal, or ion exchange resin can be mentioned as the particulate compound (a). Especially, a titanosilicate-based inorganic compound or an aluminosilicate-based inorganic compound, which has a large ion-exchange capacity and high selectivity with respect to heavy metals, is desirable.

It is efficient to use amorphous titanosilicate, which is on the market under the trade name of ATS from Engelhard Corporation, as the titanosilicate-based inorganic compound. When the aluminosilicate-based inorganic compound is used, it is preferable to use an A type or X type zeolite from the viewpoint that its ion-exchange capacity is large.

Various thermoplastic resins powder, such as polyethylene, polypropylene, polystyrene, ethylene vinyl acetate copolymer, acrylonitrile-butadiene-styrene resin, polyester such as polyethylene terephthalate, polybutylene terephthalate, or polymethyl methacrylate, polyamide such as nylon, and thermosetting resins powder such as furan resin or phenol resin, can be mentioned as the plastic powder (b) used in the present invention. Especially, the thermoplastic resin powder is desirable.

When a thermoplastic resin powder whose melt flow rate (MFR) is fairly small is used, there are cases in which a particulate compound does not easily adhere to the surface of the thermoplastic resin. On the other hand, when a thermoplastic resin powder whose MFR is fairly large is used, there are cases in which the thermoplastic resin flows without maintaining the shape of each particle if the resin is heated beyond its melting point. Therefore, it is preferable to use a thermoplastic resin powder whose MFR is between 0.02 g/10 minutes and 40 g/10 minutes. Herein, the MFR is the exit velocity of a thermoplastic resin extruded from an orifice having a specified diameter and length under the condition of predetermined temperature and pressure. More specifically, the MFR is measured according to JIS K 7210. Polyethylene is the most preferable resin among the thermoplastic resins.

The particle diameter of the plastic powder used in the present invention is associated with the particle size of a composite adsorbent which is a final aim herein. It is recommended to select a plastic powder having large-diameter particles when a large-sized composite adsorbent is produced and to select a plastic powder having small-diameter particles when a small-sized composite adsorbent is produced. From this viewpoint, it is recommended to use a plastic powder having a mean particle diameter of 0.1 μm to 200 μm, preferably 1 μm to 100 μm.

First, in order to produce the composite adsorbent in the first aspect of the present invention, there is a need to cause a plastic powder (b) to adhere to a particulate compound (a) so as to form a composite powder (c). The particulate compound may be powdery or granular. Since the adsorption speed tends to become lower when a composite adsorbent is formed if the particulate compound has particles of a too large diameter, it is preferable to use a particulate compound having a particle diameter of less than 200 μm, preferably less than 100 μm. From the viewpoint of supportability, it is preferable to use a particulate compound having particles whose shape is spherical and whose diameter is between 3 μm and 80 μm.

The plastic powder can adhere to the particulate compound by means of, for example, far-infrared radiation heating or a heating-drying furnace. It is to be noted that the “adhesion” in the present invention denotes all states in which the particulate compound and the plastic powder are firmly connected together, such as heat adhesion by fusion heating or the like, in addition to bonding by an adhesive. From the viewpoint that these can be reliably fastened, it is preferable to employ heat adhesion.

As mentioned above, in order to obtain the composite adsorbent in the first aspect of the present invention, there is a need to first obtain the composite powder (c) by causing the plastic powder to adhere to the particulate compound. This composite powder can be obtained as follows. For example, 5 to 50 parts by weight of the plastic powder are mixed with 100 parts by weight of the particulate compound, thus forming a mixture. The resulting mixture is heated beyond the melting point of the plastic powder, is then cooled, and is sieved. From the viewpoint of an effect of the present invention, it is preferable to set the adhesion quantity of the particulate compound at 50 to 95% by weight of the composite powder. The quantity of the particulate compound in the composite powder can also be estimated by measuring volatile matter. The volatile matter is measured according to a method in which a sample is left in a furnace of 930° C. for 7 minutes, is then cooled in a state in which the sample is contained in a magnetic crucible covered with a lid, and the weight of the remaining sample is measured. Since a thermally fusible polymer, such as polyethylene, is decomposed and volatilized at this temperature, the volatile matter roughly corresponds to the ratio of the thermoplastic resin in the composite adsorbent.

If the plastic powder and the particulate compound are lightly joined together at the step of heating and cooling the mixture, it is recommended to lightly crush and then sieve these. The reason is that each particle has its surface covered with fine particles having ion adsorbability, and hence the powder and the compound can be easily crushed. For example, the powder and the compound can be crushed by placing the mixture on a vibrating sieve and merely vibrating the sieve. If the particles are firmly joined together, it is recommended to smash the mixture with a grinder once and then sieve the mixture.

After having sieved the mixture, particles smaller than a predetermined sieving standard are reused, and particles larger than the sieving standard are re-crushed, thereby making it possible to adjust the particle size and reuse the particles. From the viewpoint of pressure loss and handleability, it is preferable to set the mean particle diameter of the composite powder between 75 μm (200 mesh) and 1 mm (16 mesh). The thus obtained composite powder can be used as an adsorbent material without changing its granular state. The composite adsorbent in the first aspect of the present invention can preferably be obtained according to the fourth aspect of the invention described later, in which the composite powder is mixed with an adsorptive substance together.

As described above, the composite adsorbent in the second aspect of the present invention comprises the particulate compound (a) and at least one adsorptive substance (d) selected from powdery, particulate and fibrous substances, both of which have the plastic powder (b) adhered thereto. From the viewpoint of an effect, it is preferable to set the adhesion quantity of the particulate compound at 1 to 20% by weight of the composite adsorbent. The composite adsorbent in the second aspect of the present invention can preferably be obtained according to the fifth aspect of the invention described later, in which a mixture obtained by mixing the particulate compound, the plastic powder, and an adsorptive substance together is heated beyond the melting point of the plastic powder, is then cooled, and is sieved while being crushed.

Variously shaped activated carbons, such as powdery, granular, and fibrous ones, alumina, silica alumina, or natural mordenite can be mentioned as the adsorptive substance (d). Preferably, activated carbons are used from the viewpoint of being superior in performance capabilities to adsorb free chlorine, THM, musty odors, etc. What is needed for the activated carbon is to be produced by carbonizing and activating a carbonaceous material. Preferably, the activated carbon has a specific surface area (area/weight ratio) exceeding several hundred m²/g.

For example, plants, such as wood, sawdust, charcoal, fruit shells such as coconuts shells or walnut shells, fruit seeds, by-products of pulp production, lignin, blackstrap molasses, minerals such as peat, grass peat, lignite, brown coal, bituminous coal, smokeless coal, coke, coal tar, coal pitch, oil distillation residues or oil pitch, synthesized material such as phenol, saran or acrylic resin, and natural material such as regenerated fiber (rayon), etc., can be mentioned as the carbonaceous material. Especially, plant-based coconuts shells activated carbons are preferable.

When a powdery adsorptive substance is used, the particle diameter is preferably between 75 μm and 2800 μm (between 200 mesh and 7 mesh), and, more preferably, between 100 μm to 2000 μm (between 150 mesh and 9 mesh) from the viewpoint of workability, contact efficiency with water, or resistance to water passing. When a granular adsorptive substance is used, the particle diameter is preferably between 75 μm and 1.7 mm (200 mesh and 10 mesh), and, more preferably, between 100 μm and 1.4 mm (between 150 mesh and 12 mesh) for the same reason. When a fibrous adsorptive substance is used, it is preferable to cut the adsorptive substance to be about 1 to 5 mm from the viewpoint of moldability. When a fibrous activated carbon is used, the quantity of iodine to be adsorbed is preferably between 1200 and 3000 mg/g from the viewpoint of removing free chlorine.

The composite adsorbent in the first aspect of the present invention can be obtained by preferably mixing 100 to 3000 parts by weight of the adsorptive substance typified by the activated carbon mentioned above with 100 parts by weight of the composite powder mentioned above. A known mixing method can be employed without imposing specific limitations on the mixing method. This mixture can be used as a water purification material by being automatically applied without any changes. However, more preferably, the mixture is heated beyond the melting point of the plastic powder, and is molded while being pressed, whereby the mixture can be used as a cartridge type molded article. Additionally, to give antibacterial properties to a mixture of the composite adsorbent and the activated carbon, a silver-carrying activated carbon or a silver-exchanged zeolite can be added.

The composite adsorbent in the second aspect of the present invention can be obtained by mixing the plastic powder (b), the particulate compound (a), and the adsorptive substance (d) together, then heating the resulting mixture beyond the melting point of the plastic powder, and molding the mixture while pressing it. However, preferably, the composite adsorbent can be produced by causing the plastic powder (b) to adhere to the particulate compound (a) and the adsorptive substance (d) so as to make a composite adsorbent, then heating the resulting adsorbent beyond the melting point of the plastic powder, then cooling the adsorbent, and crushing and sieving it. To do so, first, a composite adsorbent must be produced by causing the plastic powder (b) to adhere to the particulate compound (a) and the adsorptive substance (d). This composite adsorbent can be obtained, for example, by mixing 1 to 50 parts by weight of the particulate compound and 5 to 200 parts by weight of the plastic powder with 100 parts by weight of the adsorptive substance together, then heating the resulting mixture beyond the melting point of the plastic powder, then cooling the mixture, and sieving the mixture. From the viewpoint of an effect on the present invention, it is preferable to set the adhesion quantity of the particulate compound at 1 to 20% by weight of the composite adsorbent.

If the plastic powder, the particulate compound, and the adsorptive substance are lightly joined together at the step of heating and cooling the mixture, it is recommended to lightly crush and then sieve the mixture. For example, the mixture can be crushed by placing the mixture on a vibrating sieve and merely vibrating the sieve. If the particles are firmly joined together, it is recommended to create a preheated state of 60° C. to 110° C., then smash and crush the mixture with a grinder, and sieve the mixture.

After having sieved the mixture, particles smaller than a predetermined sieving standard are reused, and particles larger than the sieving standard are re-crushed, thereby making it possible to adjust the particle size and reuse the particles. The thus obtained composite adsorbent can be used as an adsorbent material without changing its granular state. However, the composite adsorbent can be mixed with an adsorptive substance. This composite adsorbent can be used as a water purification material by being automatically applied without any changes. However, the composite adsorbent can be heated more and be molded, whereby the composite adsorbent can be used as a cartridge type molded article. Additionally, to give antibacterial properties to the composite adsorbent, a silver-carrying activated carbon or a silver-exchanged zeolite can be added.

When the composite adsorbent of the present invention is used as a water purification material, a high adsorption speed can be achieved in spite of being granular, and a fine powder never flows out when water is passed therethrough. Supposedly, this reason is derived from an adhesion structure between the plastic particles and the particulate compound although this cannot be clearly described. That is, a part of each particulate compound is fastened by plastic particles, such as polyethylene, and the composite adsorbent is granular as a whole. However, on a surface on the side being fastened to the plastic particles and a surface on the opposite side, the particulate compound is never covered with the plastic particles, and the original surface state is maintained. Therefore, presumably, the reason why a fine powder never flows out is that the adsorptivity inherent in the particulate compound effectively works and that the plastic particles and the particulate compound are firmly fastened together.

Additionally, in the composite adsorbent of the second aspect of the present invention, the plastic particles and the particulate compound are fastened also to the adsorptive substance. Presumably, this forms a structure in which a classification does not easily occur.

Specific limitations are not imposed on the water passing condition when a water purifier having a column filled with the water purification material is used. For example, water is passed at a space velocity (SV) of 50 to 2000 hr⁻¹ so that the pressure drop does not become too great. Since the composite adsorbent of the present invention has a high adsorption speed, the water purifier can exhibit its performance capabilities even if the SV is set at beyond 100 hr⁻¹ and beyond 1000 hr⁻¹. Therefore, the column of the water purifier can be reduced in size.

The column is filled with the composite adsorbent of the present invention serving as a water purification material, and the water purifier can be used independently. However, the composite adsorbent may be combined with known unwoven cloth, various adsorbent materials, ceramic filtering material, or a hollow fiber membrane. Although the present invention is described in detail with reference to the following examples, the present invention is not limited to these.

### EXAMPLE 1

1 kg of a titanosilicate-based lead removing media being marketed under the trade name of ATS (mean particle diameter: 20 μm) from Engelhard Corporation and 150 g of a polyethylene powder (FLO-THENE produced by Sumitomo Seika Chemicals Co., Ltd.) having a mean particle diameter of 40 μm, an MFR of 2.0 g/10 minutes, and a melting point of 120° C. were mixed well as a particulate compound. This mixture was heated at a temperature of 160° C. for one hour by using a heating and drying device, and was cooled to room temperature.

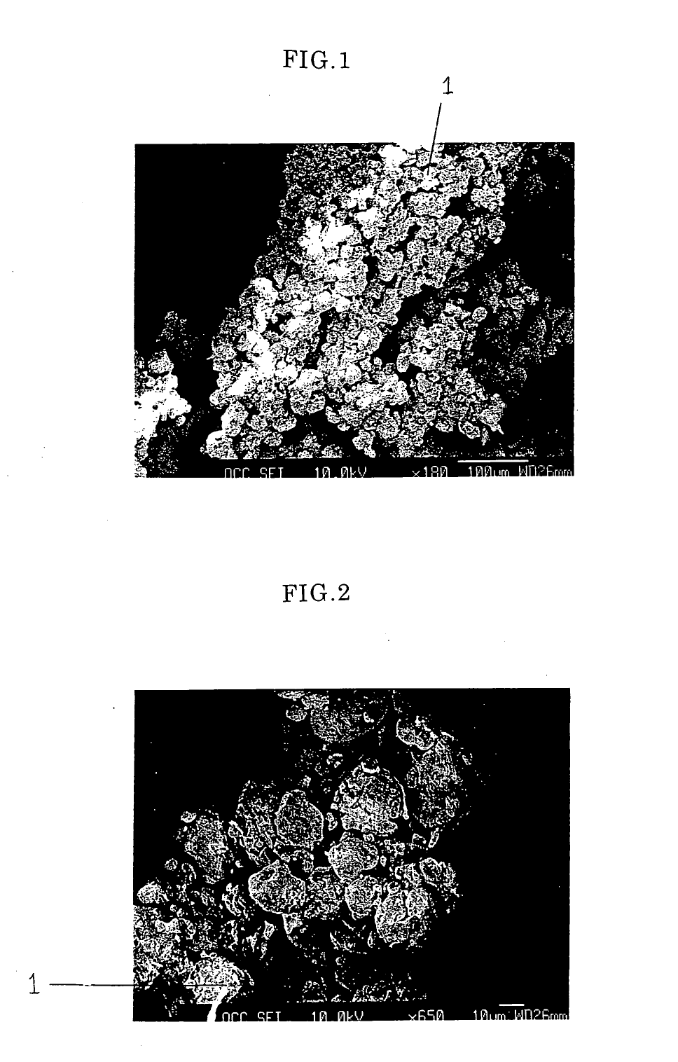

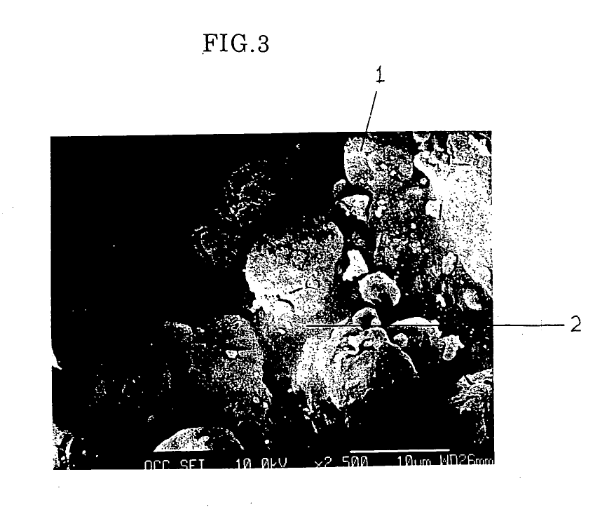

Thereafter, lumps of the mixture were crushed while being put through a vibrating sieve so as to be sieved into 30/150 mesh (upper sieve: 30 mesh, sieve opening of 0.5 mm; lower sieve: 150 mesh, sieve opening of 0.1 mm), thus obtaining a composite powder. Particles having a particle size of between 150 mesh and 30 mesh accounted for 65% of the whole. Particles having a particle size beyond 30 mesh accounted for 5%, and particles having a particle size below 150 mesh accounted for 30%. Particles below 150 mesh were reused, and particles beyond 30 mesh were re-crushed so as to be adjusted to be 30/150 mesh and be reused. The volatile matter of particles of 30/150 mesh measured herein was 25%. FIG. 1 to FIG. 3 show electron microscope photographs of the thus obtained composite powder. In the figures, 1 denotes ATS, and 2 denotes molded polyethylene. From FIG. 1 (180 magnifications) and FIG. 2 (650 magnifications), it is understood that the surface of the composite powder of the present invention is covered with spherical ATS, although polyethylene cannot be easily discerned since polyethylene is in a molded state. FIG. 3 shows a photograph of 2,500 magnifications, and it is possible to observe a state in which ATS particles are thermally adhered to polyethylene particles owing to the melting of polyethylene particles. In FIG. 3, a flat part that seems to have been once melted is polyethylene. Likewise, a flat part (polyethylene part) can be partially observed in FIG. 2, although the composite powder has a structure that cannot be easily observed since the polyethylene part lies inside the composite particles.

10 g of the thus obtained composite powder (30/150 mesh) and 90 g of a particulate activated carbon [marketed under the trade name of Kuraraycoal GW 48/100 from Kuraray Chemical Co., Ltd. (particle diameter: 0.3 mm to 0.15 mm, specific surface area: 800 m²/g)] were mixed to make a composite adsorbent. This was packed into a 60 cc column, and raw water containing 50 ppb of soluble lead (which was adjusted by adding lead nitrate so that the lead ion concentration becomes 50 ppb) was passed therethrough at a flow velocity of 1.0 liter (L)/minute (SV1000 hr⁻¹), thus measuring the removal rate of lead ions.

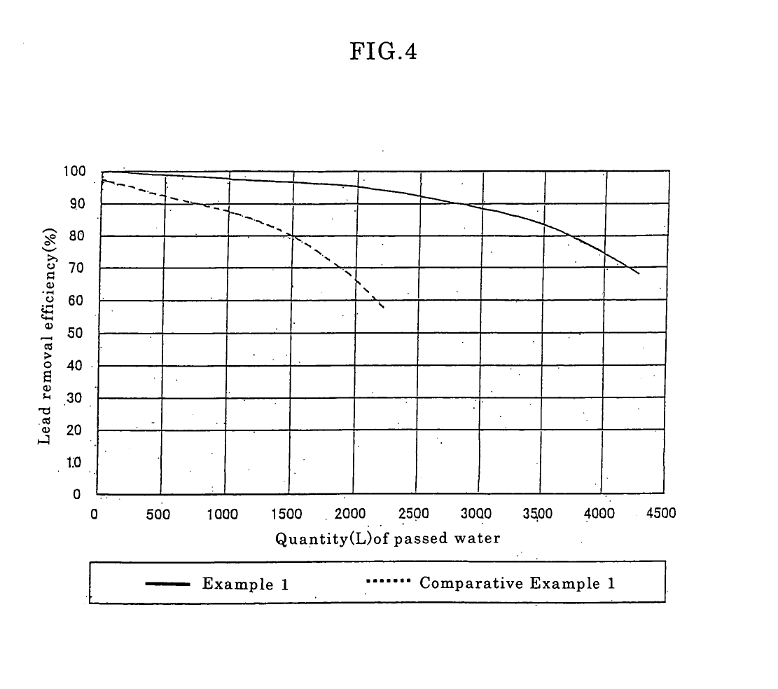

FIG. 4 shows a relationship between the quantity of passed water and the lead removal efficiency. The removal rate of lead ions is calculated according to the formula [(lead concentration on the inlet side of the column−lead concentration on the outlet side thereof)/lead concentration on the inlet side thereof]. The performance capabilities to remove lead were evaluated from the relationship between the removal rate and the quantity of passed water at the time when a quantity of water has been passed therethrough each time. The life of the adsorbent material was set at the time when the removal rate is 80%. From the result of FIG. 4, it is understood that the life of the lead removal is 3700 L and that a removal capability of 61 L is provided per cc (i.e., cubic centimeter) of the column (which is filled with blend articles). Table 1 shows results.

In this example, the removal capability to remove free chlorine and the removal capability to remove THM were also measured. As a result (not shown in a graphic form), the removal capability to remove free chlorine was 6000 L (100 L per cc of the column) with a concentration of 2 ppm at the inlet. The removal capability to remove total trihalomethanes was 800 L (13 L per cc of the column) with a concentration of 100 ppb at the inlet (which was adjusted by adding 45 ppb of chloroform, 30 ppb of bromodichloromethane, 20 ppb of dibromochloromethane, and 5 ppb of bromoform to tap water). As described above, the composite adsorbent of the present invention had an excellent performance as a water purifier.

### COMPARATIVE EXAMPLE 1

200 g of commercially-available acrylic fibers (R56D manufactured by Japan Exlan Company Limited) beaten to CSF=50 mL with a refiner were used as the micro-fibrillated fiber, and 1,500 g of titanosilicate (the trade name of ATS from Engelhard Corporation, mean particle diameter: 30 μm, spherical) which is used as a particulate compound were dispersed into 45 L of water so as to prepare a slurry-like solid-liquid mixed aqueous solution.

15 kg of a particulate activated carbon [marketed under the trade name of Kuraraycoal GW 60/150 from Kuraray Chemical Co., Ltd. (particle diameter: 0.1 mm to 0.25 mm, specific surface area: 800 m²/g)] was put into the slurry-like aqueous solution, they were then stirred well, the solid was then filtered out, the solid was further subjected to centrifugal dehydration by use of a filter cloth, and the surface water thereof was removed. 15 kg of the same dry particulate activated carbon GW60/150 as above was newly added, was then mixed, and was dried at 120° C. for 12 hours, thus making a composite particulate article.

This composite particulate article was packed into the same column as in Example 1 with a filling density of 0.50 g/mL so as to make a water purifier. The same raw water as in Example 1 was passed through the water purifier at the rate of 1.0 L/minute. As in Example 1, the lead removing capability measured herein was 32 L/cc (activated carbon), and the total trihalomethanes removing capability was at almost the same level. However, a small amount of turbid water was found at the beginning of the water passing.

### COMPARATIVE EXAMPLE 2

10 g of sulfonic acid type ion exchange fibers (diameter: 30 μm, ion exchange capacity: 2 meq/g), which were cut at intervals of 1 mm, and 90 g of the activated carbon used in Example 1 were mixed together. The resulting mixture was packed into the same 60 cc column as in Example 1, and water was passed therethrough under the same condition as in Example 1. As a result, the life of lead was 1500 L, and the removal capability per unit volume was 25 L. Although the removal capability to remove free chlorine and THM was the same as in Example 1, the removal capability to remove lead was 40% of that in Example 1. The removal capability to remove lead was inferior.

### EXAMPLES 2 TO 4

Except that the ratio of polyethylene particles to be mixed is changed, a composite adsorbent was prepared in the same way as in Example 1, and the adsorptivity of soluble lead was evaluated in the same way as in Example 1. The volatile matter of the composite adsorbent, which has a relationship with the quantity of polyethylene as described above, was measured as a reference value. Table 1 shows a relationship between the ratio of a polyethylene powder to be mixed and the removal capability to remove lead. The clarity of passed water flowing out was observed by using a color comparison tube.

TABLE 1
Mixed Ratio of Polyethylene Powder and Removal Capability of Soluble Lead

| | | Volatile | | | Soluble lead |
|---|---|---|---|---|---|
| | Mixed ratio of | matter of | Mixed | | removing |
| | polyethylene | composite | ratio of | Clarity of | capability |
| | powder (wt %) | powder (%) | ATS (wt %) | passed water | (L/cc) |
| Example 1 | 13 | 25 | 87 | Colorless | 61 |
| | | | | (no turbidity) | |
| Example 2 | 20 | 35 | 80 | Colorless | 48 |
| | | | | (no turbidity) | |
| Example 3 | 30 | 48 | 70 | Colorless | 31 |
| | | | | (no turbidity) | |
| Example 4 | 3 | 6 | 97 | Colorless | 62 |
| | | | | (no turbidity) | |

### EXAMPLES 5 TO 7

Some composite adsorbents were made using polyethylene whose mean particle diameter is 40 μm and that differs in MFR, and a relationship between the MFR and the capability of the composite adsorbent was measured. The result is shown in Table 2. The quantity of resin particles to be mixed was set at 13%.

TABLE 2
MFR of Polyethylene and Soluble Lead Removing Capability

| | | MFR of | | | Soluble lead |
|---|---|---|---|---|---|
| | Mixed ratio of | polyethylene | Mixed | | removing |
| | polyethylene | (g/10 | ratio of | Clarity of | capability |
| | powder (wt %) | minutes) | ATS (wt %) | passed water | (L/cc) |
| Example 5 | 13 | 0.02 | 87 | Colorless | 62 |
| | | | | (no turbidity) | |
| Example 6 | 13 | 10 | 87 | Colorless | 48 |
| | | | | (no turbidity) | |
| Example 7 | 13 | 40 | 87 | Colorless | 35 |
| | | | | (no turbidity) | |

### EXAMPLE 8

Except that polypropylene (PP) is used as thermoplastic resin, a composite adsorbent was prepared in the same way as in Example 1. The MFR of PP was 1.0, and the particle diameter thereof was 40 μm. The volatile matter of the thus obtained composite adsorbent was 30%. The adsorptivity of soluble lead that was measured in the same way as in Example 1 was 58 L/cc, exhibiting an excellent performance. Turbidity was not found at the beginning of the water passing.

### EXAMPLE 9

Fine particles of silica-alumina-based zeolite were used as ion adsorptive fine particles. This zeolite having a mean particle diameter of 3 μm was spherical. Except that the same polyethylene as in Example 1 is used as thermoplastic resin particles and that the quantity of polyethylene to be mixed is set at 20%, a composite adsorbent was prepared in the same way as in Example 1. The volatile matter of the thus obtained composite adsorbent was 37%, and the adsorptivity of soluble lead was 41 L/cc. Turbidity was not found at the beginning of the water passing.

### EXAMPLE 10

1 kg of activated carbon GW60/150 (activated carbon particle diameter: 60 to 150 mesh) that was produced by Kuraray Chemical Co., Ltd., 100 g of the composite powder prepared in Example 1, and 100 g of a polyethylene powder whose MFR is 0.5 g/10 minutes, whose melting point is 130° C., and whose mean particle diameter is 30 μm were mixed together at this ratio. Thereafter, the activated carbon was packed into a cylindrical frame whose outer diameter is 42 mm, whose inner diameter is 25 mm, and whose height is 95 mm, was then heated and pressed (1 MPa) at 160° C. for 17 minutes by use of a heating press, and was molded into a cartridge.

A water purifier was made by attaching the cartridge to a housing, and water adjusted so that the free chlorine concentration is 2 ppm and the soluble lead concentration is 50 ppb was supplied thereto at the rate of 2 L/minute. No turbidity was found at the beginning of the water passing. The soluble lead removing capability of the activated carbon structure was 4800 L (56 L per cc of the column), and the free chlorine removing capability (up to the life of 80% removal) was 4500 L (53 L per cc of the column), exhibiting a sufficient performance for practical use.

### EXAMPLE 11

540 g of a titanosilicate-based lead removing media ATS (mean particle diameter: 20 μm) produced by Engelhard Corporation as a particulate compound, 180 g of a polyethylene powder (FLO-THENE UF-1.5 produced by Sumitomo Seika Chemicals Co., Ltd.) whose mean particle diameter is 40 μm, whose MFR is 1.5 g/10 minutes, and whose melting point is 120° C., and 2280 g of particulate activated carbon [GW10/32 produced by Kuraray Chemical Co., Ltd. (particle diameter: 1.7 mm to 0.5 mm, specific surface area: 800 m²/g)] were mixed together. The resulting mixture was heated at a temperature of 150° C. for one hour by using a heating and drying device, and was crushed by using a crusher.

Thereafter, lumps of the mixture were sieved into 10/30 mesh while being put through a vibrating sieve (upper sieve: 10 mesh, sieve opening of 1.7 mm; lower sieve: 30 mesh, sieve opening of 0.5 mm), thus obtaining a composite adsorbent. Particles having a particle size of between 30 mesh and 10 mesh accounted for 75% of the whole. Particles having a particle size beyond 10 mesh accounted for 5%, and particles having a particle size below 30 mesh accounted for 20%.

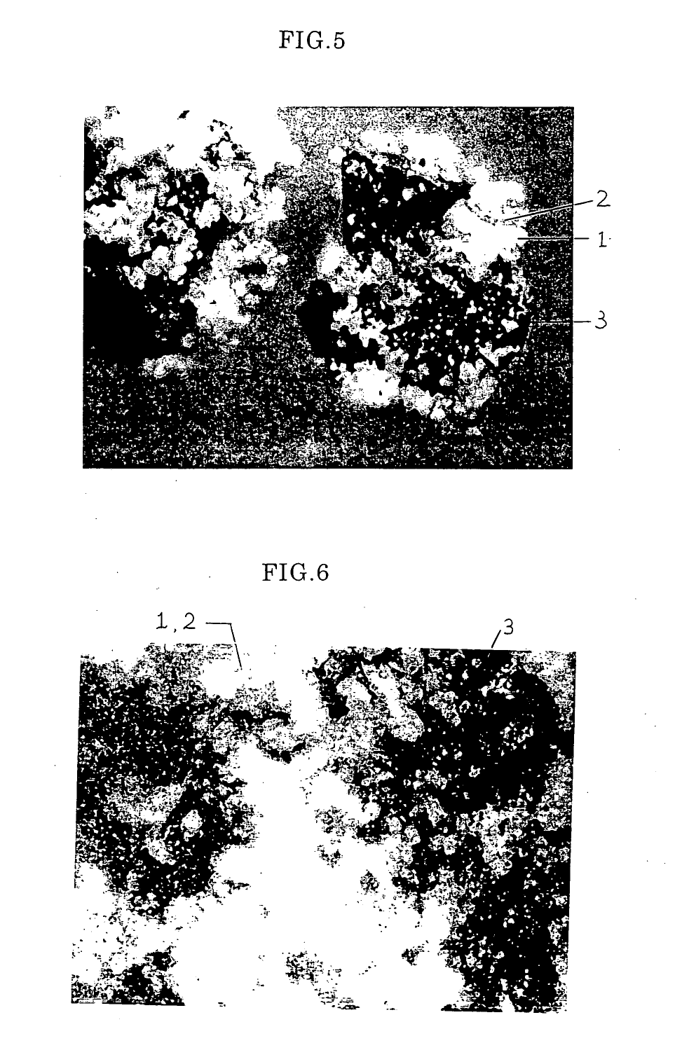

FIG. 5 and FIG. 6 show photomicrographs of the composite adsorbent obtained above. 1 denotes ATS, 2 denotes molded polyethylene, and 3 denotes activated carbon. From FIG. 5 (60 magnifications) and FIG. 6 (200 magnifications), it is understood that the surface of the composite adsorbent of the present invention is partially covered with spherical ATS, although the polyethylene cannot be easily discerned since it is in a molded state.

150 g of the composite adsorbent obtained as above was packed into a 300 cc column, and raw water containing 50 ppb of soluble lead (which was adjusted by adding lead nitrate so that the lead ion concentration becomes 50 ppb) was passed therethrough at a flow velocity of 0.75 L/minute (SV150 hr⁻¹), thus measuring the removal rate of lead ions.

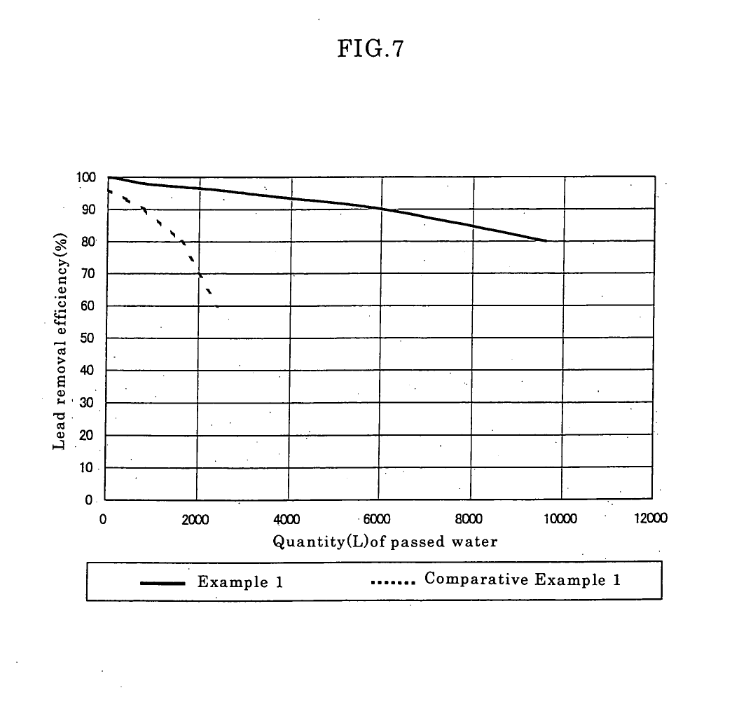

FIG. 7 shows a relationship between the quantity of passed water and the lead removal efficiency. The removal rate of lead ions is calculated according to the formula [(lead concentration on the inlet side of the column−lead concentration on the outlet side thereof)/lead concentration on the inlet side thereof]. The performance capabilities to remove lead were evaluated from the relationship between the removal rate and the quantity of passed water at the time when a quantity of water has been passed therethrough each time. The life of the adsorbent material was set at the time when the removal rate is 80%. From the result of FIG. 7, it is understood that the life of the lead removal is 9600 L and that a removal capability of 32 L is provided per cc of the column.

In this example, the removal capability to remove free chlorine and the removal capability to remove total THM were also measured. As a result (not shown in a graphic form), the removal capability to remove free chlorine was 24,000 L (80 L per cc of the column) with a concentration of 2 ppm at the inlet. The removal capability to remove total trihalomethanes was 900 L (3 L per cc of the column) with a concentration of 100 ppb at the inlet (which was adjusted by adding 45 ppb of chloroform, 30 ppb of bromodichloromethane, 20 ppb of dibromochloromethane, and 5 ppb of bromoform to tap water).

### EXAMPLE 12

850 g of a titanosilicate-based lead removing media ATS (mean particle diameter: 20 μm) produced by Engelhard Corporation as a particulate compound, 300 g of a polyethylene powder (FLO-THENE UF-1.5 produced by Sumitomo Seika Chemicals Co., Ltd.) whose mean particle diameter is 40 μm, whose MFR is 1.5 g/10 minutes, and whose melting point is 120° C., and 1700 g of particulate activated carbon [GW10/32 produced by Kuraray Chemical Co., Ltd. (particle diameter: 1.7 mm to 0.5 mm, specific surface area: 800 m²/g)] were mixed together. The resulting mixture was heated at a temperature of 150° C. for one hour by using a heating and drying device, and was crushed by using a crusher.

Thereafter, lumps of the mixture were sieved into 10/30 mesh while being put through a vibrating sieve (upper sieve: 10 mesh, sieve opening of 1.7 mm; lower sieve: 30 mesh, sieve opening of 0.5 mm), thus obtaining a composite adsorbent. Particles having a particle size of between 30 mesh and 10 mesh accounted for 80% of the whole. Particles having a particle size beyond 10 mesh accounted for 5%, and particles having a particle size below 30 mesh accounted for 15%.

200 g of the composite adsorbent obtained as above and 1000 g of particulate activated carbon [GW10/32 produced by Kuraray Chemical Co., Ltd. (particle diameter: 1.7 mm to 0.5 mm, specific surface area: 800 m²/g)] were mixed well to make a diluted composite adsorbent. 150 g of the composite adsorbent obtained here was packed into a 300 cc column, and raw water containing 50 ppb of soluble lead (which was adjusted by adding lead nitrate so that the lead ion concentration becomes 50 ppb) was passed therethrough at a flow velocity of 0.75 L/minute (SV150 hr⁻¹), thus measuring the removal rate of lead ions.

The same measurement as in Example 1 was performed. As a result, it was understood that the life of the lead removal is 3600 L and that the removal capability is 12 L per cc of the column.

In this example, the removal capability to remove free chlorine and the removal capability to remove total THM were also measured in the same way as in Example 1. As a result (not shown in a graphic form), the removal capability to remove free chlorine was 30,000 L (100 L per cc of the column). The removal capability to remove total trihalomethanes was 1,200 L (4 L per cc of the column). Thus, the composite adsorbent of the present invention had an excellent performance for use in a water purifier.

### COMPARATIVE EXAMPLE 3

200 g of commercially-available acrylic fibers (R56D manufactured by Japan Exlan Company Limited) beaten to CSF=50 mL with a refiner were used as the micro-fibrillated fiber and 1,500 g of titanosilicate (the trade name of ATS from Engelhard Corporation, mean particle diameter: 20 μm, spherical) which is used as a particulate compound were dispersed into 45 L of water so as to prepare a slurry-like solid-liquid mixed aqueous solution.

15 kg of a particulate activated carbon [marketed under the trade name of Kuraraycoal GW10/32 from Kuraray Chemical Co., Ltd. (particle diameter: 1.7 mm to 0.5 mm, specific surface area: 800 m²/g)] was put into the slurry-like aqueous solution, they were then stirred together, the solid was then filtered out, the solid was further subjected to centrifugal dehydration by use of a filter cloth, and the surface water thereof was removed. 22.5 kg of the same dry particulate activated carbon GW10/32 as above was newly added, was then mixed, and was dried at 120° C. for 12 hours, thus making a composite particulate article.

This composite particulate article was packed into the same column as in Example 1 with a filling density of 0.50 g/mL so as to make a water purifier. The same raw water as in Example 1 was passed through the water purifier at the rate of 0.75 L/minute. Measurement was performed in the same way as in Example 1. As a result, the lead removing capability measured herein was 5 L/cc (activated carbon), and the total trihalomethanes removing capability was at almost the same level. However, a minute amount of turbid water was found at the beginning of the water passing.

### EXAMPLES 13 TO 16

Except that the ratio of polyethylene particles to be mixed is changed, a composite adsorbent was prepared in the same way as in Example 11, and the adsorptivity of soluble lead was evaluated in the same way as in Example 2. Table 3 shows a relationship between the ratio of a polyethylene powder to be mixed and the removal capability to remove lead. The clarity of passed water flowing out was observed by using a color comparison tube.

TABLE 3
Mixed Ratio of Polyethylene Powder and Removal Capability of Soluble Lead

| | | | | | Soluble lead |
|---|---|---|---|---|---|
| | Mixed ratio of | Mixed | Mixed ratio | | removing |
| | polyethylene | ratio of | of activated | Clarity of | capability |
| | powder (wt %) | ATS (wt %) | carbon (wt %) | passed water | (L/cc) |
| Example 13 | 1.7 | 5 | 93.3 | Colorless | 12 |
| | | | | (no turbidity) | |
| Example 14 | 3 | 5 | 92 | Colorless | 10.5 |
| | | | | (no turbidity) | |
| Example 15 | 5 | 5 | 90 | Colorless | 9.7 |
| | | | | (no turbidity) | |
| Example 16 | 0.2 | 5 | 94.8 | Colorless | 12.5 |
| | | | | (no turbidity) | |

### EXAMPLES 17 TO 19

Some composite adsorbents were made using polyethylene whose mean particle diameter is 40 μm and that differs in MFR, and a relationship between the MFR and the capability of the composite adsorbent was measured. The result is shown in Table 4. The quantity of resin particles to be mixed was set at 10%.

TABLE 4
MFR of Polyethylene Powder and Soluble Lead Removing Capability

| | | MFR of | | | Soluble lead |
|---|---|---|---|---|---|
| | Mixed ratio of | polyethylene | Mixed | | removing |
| | polyethylene | (g/10 | ratio of | Clarity of | capability |
| | powder (wt %) | minutes) | ATS (wt %) | passed water | (L/cc) |
| Example 17 | 1.5 | 0.02 | 98.5 | Colorless | 12.5 |
| | | | | (no turbidity) | |
| Example 18 | 1.5 | 10 | 98.5 | Colorless | 10.5 |
| | | | | (no turbidity) | |
| Example 19 | 1.5 | 40 | 98.5 | Colorless | 9 |
| | | | | (no turbidity) | |

### EXAMPLE 20

Except that polypropylene (PP) is used as thermoplastic resin, a composite adsorbent was prepared in the same way as in Example 12. The MFR of PP was 1.0, and the particle diameter thereof was 40 μm. The adsorptivity of soluble lead measured in the same way as in Example 2 was 11.5 L/cc, exhibiting an excellent performance. Turbidity was not found at the beginning of the water passing.

### EXAMPLE 21

Fine particles of silica-alumina-based zeolite were used as ion-exchange fine particles. This zeolite having a mean particle diameter of 3 μm was spherical. Except that the same polyethylene as in Example 12 is used as thermoplastic resin particles and that the quantity of polyethylene to be mixed is set at 100 g, a composite adsorbent was prepared in the same way as in Example 12. The adsorptivity of soluble lead measured in the same way as in Example 12 was 7.5 L/cc. Turbidity was not found at the beginning of the water passing.

### EXAMPLE 22

1 kg of activated carbon GW10/32 (particle diameter: 1. 7 mm to 0.5 mm, specific surface area: 800 m²/g) that was produced by Kuraray Chemical Co., Ltd., 200 g of the composite powder prepared in Example 1, and 200 g of a polyethylene powder (FLO-THENE UF-1.5) whose mean particle diameter is 40 μm, whose MFR is 1.5 g/10 minutes, and whose melting point is 120° C. were mixed together at this ratio. Thereafter, the activated carbon was packed into a cylindrical frame whose outer diameter is 42 mm, whose inner diameter is 25 mm, and whose height is 95 mm, was then heated and pressed (1 MPa) at 125° C. for 80 minutes by use of a heating press, and was molded into a cartridge.

A water purifier was made by attaching the cartridge to a housing, and water adjusted so that the free chlorine concentration is 2 ppm and so that the soluble lead concentration is 50 ppb was supplied thereto at the rate of 2 L/minute. No turbidity was found at the beginning of the water passing. The soluble lead removing capability of the activated carbon structure was 4800 L (56 L per cc of the column), and the free chlorine removing capability (up to the life of 80% removal) was 4500 L (53 L per cc of the column), exhibiting a sufficient performance for practical use.

### INDUSTRIAL APPLICABILITY

The composite adsorbent of the present invention is, of course, excellent in adsorptivity to adsorb total trihalomethanes (THM), free chlorine, heavy metals such as lead, etc., and is capable of adsorbing and removing these elements in a well-balanced manner. In addition, a fine powder of a particulate compound never flows out when water is passed therethrough. Therefore, the composite adsorbent is preferably used for water clarification. Moreover, since the composite adsorbent is less prone to cause discrepancies in adsorbability between respective purifiers, this can be stably supplied.

1. A composite adsorbent comprising: a composite powder (c) which is composed of a particulate compound (a) and a plastic powder (b) adhered to the particulate compound (a); and at least one adsorptive substance (d) selected from the group consisting of powdery, particulate and fibrous substances.

2. A composite adsorbent comprising: a particulate compound (a); and at least one adsorptive substance (d) selected from the group consisting of powdery, particulate and fibrous substances; both the particulate compound (a) and at least one adsorptive substance (d) having a plastic powder (b) adhered thereto.

3. The composite adsorbent according to claim 1, wherein the particulate compound (a) is 200 μm or less in mean particle diameter.

4. The composite adsorbent according to claim 1, wherein the particulate compound has an ion exchanging function.

5. The composite adsorbent according to claim 1, wherein the particulate compound is a titanosilicate-based compound.

6. The composite adsorbent according to claim 1, wherein the particulate compound is an aluminosilicate-based compound.

7. The composite adsorbent according to claim 1, wherein an adhesion quantity of the particulate compound is 50 to 95% by weight of the composite powder.

8. The composite adsorbent according to claim 2, wherein an adhesion quantity of the particulate compound is 1 to 20% by weight of the composite adsorbent.

9. The composite adsorbent according to claim 1, wherein the plastic powder (b) is thermoplastic resin.

10. The composite adsorbent according to claim 9, wherein a melt flow rate of the thermoplastic resin ranges from 0.02 g/10 minutes to 40 g/10 minutes.

11. The composite adsorbent according to claim 9, wherein the thermoplastic resin is polyethylene.

12. The composite adsorbent according to claim 1, wherein the adsorptive substance (d) is an activated carbon.

13. The composite adsorbent according to claim 1, wherein the composite adsorbent is a molded article.

14. A composite powder (c) comprising a particulate compound (a) and a plastic powder (b) adhered to the particulate compound (a).

15. A method for producing a composite adsorbent, comprising: muting a particulate compound and a plastic powder together; heating a resulting mixture beyond a melting point of the plastic powder; cooling the mixture; sieving the mixture and thereby making a composite powder; and mixing the composite powder with an adsorptive substance.

16. The method for producing a composite adsorbent according to claim 15, further comprising performing pressing and molding operations.

17. A method for producing a composite adsorbent, comprising: mixing a particulate compound, a plastic powder, and an adsorptive substance together; heating a resulting mixture beyond a melting point of the plastic powder; cooling the mixture; and crushing and sieving the mixture.

18. The method for producing a composite adsorbent according to claim 17, further comprising additionally mixing an adsorptive substance therewith.

19. A water purification material comprising the composite adsorbent according to claim 1.

20. A water purifier comprising the water purification material according to claim 19.
